(19) United States
(12) Patent Application Publication
(10) Pub. No.: US 2005/0053821 A1
(43) Pub. Date: Mar. 10, 2005

(54) Self-moisturizing proton exchange membrane, membrane-electrode assembly and fuel cell

(76) Inventor: Bor Z. Jang, Fargo, ND (US)

Correspondence Address: Bor Z Jang, 2902, 28 AVE, S.W., FARGO, ND, 58103, US

(21) Appl. No.: 10/657,038

(22) Filed: Sep. 8, 2003

(51) Int. Cl. H01M 8/10; H01M 4/94

(52) U.S. Cl. 429/33; 429/40

(57) ABSTRACT

A self-moisturizing polymer electrolyte membrane (PEM) composition, a membrane-electrode assembly, and a fuel cell. The PEM composition comprises (a) a proton-conducting polymer containing a detachable hydrogen ion and a counter-ion bonded to the polymer; and (b) a deliquescent material for keeping the membrane wet and for detaching the hydrogen ion to facilitate proton transport in the membrane. Alternatively, the deliquescent material may be strategically located on the gas flow field channels, gas-diffusion electrode or backing layers, and/or electro-catalyst layers. A preferred PEM polymer is poly(perfluoro sulfonic acid). This self-moisturizing PEM obviates the need to have a pre-humidifying structure or a complex flow field design in a fuel cell.

### FIELD OF THE INVENTION

This invention relates generally to a polymer electrolyte membrane (PEM) for use in a fuel cell, and more particularly to a self-moisturizing PEM, membrane/electrode assembly and fuel cell.

### BACKGROUND OF THE INVENTION

A fuel cell converts chemical energy into electrical energy and some thermal energy by means of a chemical reaction between hydrogen-containing fuel and oxygen. As compared to other energy sources, fuel cells provide advantages that include low pollution, high efficiency, high energy density and simple fuel recharge. Fuel cells can be used in electrochemical engines, portable power supplies for various microelectronic and communication devices, standby power supply facilities, power generating systems, etc. Further, fuel cells utilize renewable resources and provide an alternative to burning fossil fuels to generate power.

The chemical reaction of a fuel cell requires the presence of an electrolyte, electrodes and catalysts. Based on the electrolyte type, the fuel cell is classified as alkaline fuel cell (AFC), phosphoric acid fuel cell (PAFC), molten carbonate fuel cell (MCFC), solid oxide fuel cell (SOFC), and proton exchange membrane or polymer electrolyte membrane fuel cell (PEM-FC). The PEM-type fuel cell has been a topic of highly active R&D efforts during the past decade. A PEM-FC uses hydrogen or hydrogen-rich reformed gases as the fuel while a direct-methanol fuel cell (DM-FC) uses methanol solution. A DM-FC also contains a PEM interposed between the two electrodes. PEM-FC and DM-FC are collectively referred to as the PEM-type fuel cell.

In a DM-FC, a mixture of methanol and water is circulated past an anode that is separated from a cathode by a membrane that is selectively permeable to protons. The following chemical reaction takes place at the anode.
Anode: CH₃OH+H₂O→CO₂+6H⁺+6e⁻ (1)
The protons generated at the anode pass through the membrane to the cathode side of the fuel cell. The electrons generated at the anode travel to the cathode side of the fuel cell by passing through an external load that connects the anode and cathode. Air or an alternative oxygen source is present at the cathode where the electro-reduction of oxygen occurs resulting in the following chemical reaction:
Cathode: 1.5O₂+6H⁺+6e⁻→3H₂O (2)

A PEM-type fuel cell is typically composed of a seven-layered structure, including a central polymer electrolyte membrane for proton transport, two electro-catalyst layers on the two opposite sides of the electrolyte membrane in which the chemical reactions occur, two gas diffusion electrodes (GDEs) or backing layers stacked on the corresponding electro-catalyst layers (each GDE comprising porous carbon paper or cloth through which reactants and reaction products diffuse in and out of the cell), and two flow field plates stacked on the GDEs. The flow field plates are made of carbon, metal, or composite graphite fiber plates which also serve as current collectors. Gas-guiding channels are defined on a GDE facing a flow field plate, or on a flow field plate surface facing a GDE. Reactants and reaction products (e.g., water) are guided to flow into or out of the cell through the flow field plates. The sconfiguration mentioned above forms a basic fuel cell unit. Conventionally, a fuel cell stack comprises a number of basic fuel cell units that are electrically connected in series to provide a desired output voltage. If desired, cooling plates and humidifying plates may be added to assist in the operation of a fuel cell stack.

Two or three of the above-described seven (7) layers may be integrated into a compact assembly, e.g., the membrane-electrode assembly (MEA). The MEA typically includes a selectively permeable polymer electrolyte membrane bonded between two electrodes (an anode and a cathode). Typically, the anode and the cathode is each bonded to an electro-catalyst layer, as described above, or each contains an electro-catalyst phase dispersed therein. Commonly used electro-catalysts include noble metals (e.g., Pt), rare-earth metals (e.g., Ru), and their alloys. Known processes for fabricating high performance MEAs involve painting, spraying, screen-printing and hot-bonding catalyst layers onto the electrolyte membrane and/or the electrodes.

Hydrogen transport through the PEM layer in a PEM-type fuel cell requires the presence of water molecules within the membrane such as poly(perfluoro sulfonic acid), its derivative, copolymer, or mixture. Consequently, it is critical to maintain adequate membrane hydration in order for the fuel cell to function properly. In addition to maintaining adequate ionic conductivity and proton transport, uniform membrane hydration serves to prevent localized drying, or hot spots, that could result from higher localized resistance. In general, dehydration may impede performance, increase resistive power losses and degrade the structure of the membrane.

In conventional fuel cells, membrane hydration is achieved by humidifying the fuel (e.g. hydrogen gas) and oxidant gases (oxygen or air) prior to their introduction into the fuel cell. One commonly used method for pre-humidifying fuel cell gas streams is to employ membrane-based humidifiers (e.g., Reid, U.S. Pat. No. 6,403,249, Jun. 11, 2002). In these situations, reactant moisture is added by flowing the respective gases on one side of a water vapor exchange membrane while flowing deionized water on the opposite side of the membrane. Water is transported across the membrane to humidify the fuel and oxidant gases. Another known technique for pre-humidifying the reactant gas streams entails exposing the gases directly to water in an evaporation chamber to permit the gas to absorb evaporated water. Alternatively, humidification may be achieved by directly injecting or aspirating water into the respective gas streams before introducing them into the fuel cell.

Generally, pre-humidification is undesirable because it requires auxiliary fuel cell components, increasing the relative complexity of fuel cell systems. For instance, pre-humidification generally requires dedicated components for storing and transporting water. Auxiliary water storage and transport components reduce operating efficiency and add to the overall weight and cost of the system. Additional weight is an undesirable feature for a fuel cell if the cell is to be used in a portable microelectronic device such as a mobile phone or a personal data assistant (PDA). Additional components may also present system reliability issues. For example, where fuel cells are operated in sub-freezing conditions, water solidification can result in the weakening of mechanical components.

Wynne, et al. (U.S. Pat. No. 6,207,312, Mar. 27, 2001) disclosed a self-humidifying fuel cell that made use of the reaction product (water) as a source of PEM moisture, avoiding the use of auxiliary components. However, this fuel cell requires the design and construction of complex flow field channels in the gas diffusion electrodes or the flow field plates.

### SUMMARY OF THE INVENTION

It is an object of this invention to provide a self-moisturizing polymer electrolyte membrane (PEM), a membrane-electrode assembly (MEA) and a fuel cell, which are capable of maintaining membrane hydration during the storage and operation of the fuel cell.

It is another object of this invention to provide a PEM fuel cell in which membrane hydration is maintained using water provided originally in the PEM material or water as a byproduct of electrochemical reactions within the fuel cell.

It is a further object of this invention to provide a PEM fuel cell which does not require components dedicated to pre-humidification of reactant gas streams.

These and other objects of the invention are achieved by the PEM composition, the MEA and the fuel cell of the present invention. A self-moisturizing PEM-type fuel cell has a membrane electrode assembly (MEA), comprising an ion-exchange membrane interposed between catalyzed anode and cathode electrodes. The MEA is interposed between a pair of gas diffusion backings, and the resulting structure is interposed between fuel and oxidant flow field plates. The fuel flow field plate has a fuel stream inlet, a fuel stream outlet, and means for flowing the fuel stream therebetween. The oxidant flow field plate has an oxidant stream inlet, an oxidant stream outlet, and means for flowing the oxidant stream therebetween.

In a preferred embodiment, the PEM composition comprises a proton-conducting polymer and a deliquescent material dispersed in this polymer. Suitable deliquescent materials include, but are not limited to, calcium chloride, calcium bromide, potassium biphosphate, potassium acetate and combinations thereof A deliquescent material absorbs an essentially constant amount of moisture to keep the proton mobile in the PEM structure. In another preferred embodiment, a deliquescent material is strategically positioned at some points along the fuel and/or oxidant flow paths (each from the flow field surface, through the gas diffusion electrode or backing plate, further through the electro-catalyst layer, to the PEM layer). The presence of a deliquescent material acts to maintain a dynamic equilibrium of water vapor between the deliquescent material and the PEM layer.

It may be noted that Nitzan discloses a “paper battery” or “open cell” (U.S. Pat. No. 5,652,043 (Jul. 29, 1997); U.S. Pat. No. 5,811,204 (Sep. 22, 1998); and U.S. Pat. No. 5,897,522 (Apr. 27, 1999)) that comprises a first layer of insoluble negative pole, a second layer of insoluble positive pole and a third layer of aqueous electrolyte, the third layer being disposed between the first and second layers and including (a) a deliquescent material for keeping the open cell wet at all times, (b) an electro-active soluble material for obtaining required ionic conductivity, and (c) a water-soluble polymer for obtaining a required viscosity for adhering the first and second layers to the third layer. Nitzan's approach is fundamentally different and distinct from our invention in several ways: (1) In Nitzan's invention, the electrolyte is directly open to the atmospheric air through the four side surfaces. The water vapor in the atmosphere is up-taken by the deliquescent material dissolved in the electrolyte to keep the aqueous electrolyte hydrated. In contrast, the PEM layer in our fuel cell is the innermost layer and is not directly open to the outside air. The PEM is a polymer solid electrolyte, not a liquid electrolyte. The moisture needed to keep the protons mobile could come from the water added during the fuel cell manufacturing process, from the fuel or oxidant streams (if they naturally contain some moisture), and/or from the reaction. (2) Since there is no external casing in Nitzan's battery configuration, a water-soluble polymer has to be dissolved in the electrolyte to provide bonding between the electrolyte layer and the two respective electrodes. By contrast, water does not dissolve the electrolyte in our fuel cell since PEM is not water soluble. (3) Nitzan's open cell is for a battery, not a fuel cell.

### BRIEF DESCRIPTION OF THE DRAWINGS

FIG. 1 Schematic of a PEM fuel cell assembly in accordance with the present invention.

### DETAILED DESCRIPTION OF THE PREFERRED EMBODIMENTS

The present invention provides a self-moisturizing polymer electrolyte membrane (PEM) composition, a membrane-electrode assembly, and a fuel cell. The PEM composition comprises (a) a proton-conducting polymer containing a detachable hydrogen ion and a counter-ion bonded to the polymer; and (b) a deliquescent material for keeping the membrane wet, thereby helping to detach the hydrogen ion to facilitate proton transport in the membrane.

In one preferred embodiment, the PEM is an ion exchange membranes having sulfonic acid groups. These materials hydrate when immersed in water, with hydrogen ion H⁺ detached from sulfonic ion, SO₃⁻. The general structure of the sulfonic acid membranes that have received extensive attention for use in fuel cells and are sold under the trade name Nafion® by E. I. du Pont Company is as follows: 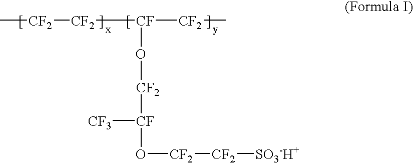
where x and y are integers selected from 1 to 100,000, preferably from 1 to 20,000, most preferably from 100 to 10,000. A similar polymer that is also suitable for use as a PEM is given as:

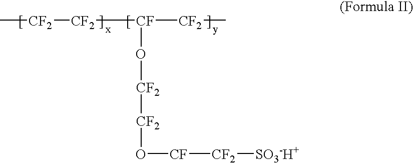

Sulfonic acid polymers having a shorter chain between the pendant functional group (side group) and the main polymer backbone absorb less water at a given concentration of functional group in the polymer than do polymers having the general structure as shown by Formula I and II. The concentration of functional group in the dry polymer is expressed as an equivalent weight. Equivalent weight is defined, and conveniently determined by standard acid-base titration, as the formula weight of the polymer having the functional group in the acid form required to neutralize one equivalent of base. In a more general form, this group of proton-conducting polymers may be represented by the formula: 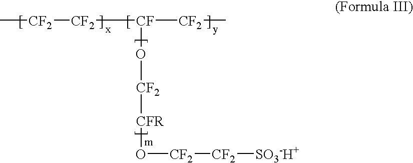
where x and y are integers selected from 1 to 100,000, m is an integer selected from 0 to 10 and R is a functional group selected from the group consisting of H, F, Cl, Br, I, and CH₃.

Another class of PEM polymers suitable for use in the fuel cell is characterized by a structure having a substantially fluorinated backbone which has recurring pendant groups attached thereto and represented by the general formula:
—O(CFR_{f}′)_{b}—(CFR_{f})ₐ—SO₃H (Formula W)
where a=0-3, b=0-3, a+b=at least 1, R_{f} and R_{f}′ are independently selected from the group consisting of a halogen and a substantially fluorinated alkyl group having one or more carbon atoms.

Still another group of sulphonic acid polymers suitable for the present fuel cell PEM applications comprises a repeating unit represented by the following formula: 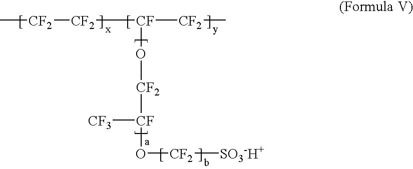
where a is 0, 1, or 2, b is 2 or 3, x and y are positive integer numbers and x/y ratio is of 10 or less. This polymer was found by Noaki, et al. (U.S. Pat. No. 5,449,697, Sep. 12, 1995) to be a good fuel cell PEM material. We have found that the addition of a deliquescent material helps to maintain an essentially constant moisture level in the sulfonic acid polymer-based PEM layer of a fuel cell.

The above polymers have a detachable hydrogen ion (proton) that is weakly attached to a counter-ion (e.g., SO₃⁻), which is covalently bonded to a pendant group of the polymer. While the general structures shown above are representative of several groups of polymers of the present invention, they are not intended to limit the scope of the present invention. It would become obvious to those skilled in the art, from the relationships presented herein that other sulfonic acid functional polymers having pendant chains, sterically hindered sulfonate groups or the like would absorb some water and conduct protons. For instance, the derivatives and copolymers of the aforementioned sulfonic acid polymers, alone or in combination with other polymers to form polymer blends, may also be used as PEM in the invented fuel cell.

A deliquescent material refers to a hygroscopic agent, a desiccant composition, a water absorbent, or a moisture exchange element or compound. These materials are able to absorb the moisture from the atmospheric air and keep a material or structure moistened. In an enclosed or partially closed container, these materials can help maintain a dynamic moisture equilibrium between these materials and a target material inside the container.

Atmospheric water vapor can be utilized for useful purposes through the use of many compounds which are extremely hygroscopic in nature. A hygroscopic material can absorb water out of the atmosphere causing the material or its mixture become deliquescent. Indeed, there are some solid compounds which are so hygroscopic that they will literally create their own self solutions, and continue to dilute themselves even when a solution is formed because the solutions of these compounds are in turn hygroscopic.

The membrane composition of this invention comprises a combination of a strongly hydroscopic agent, and a proton conducting polymer. The hygroscopic agents are preferably those which will form a pasty mix by absorbing atmospheric water vapor. A variety of metal halides such as aluminum chloride, magnesium chloride, calcium chloride, zinc chloride, or iron chloride are very useful as the hygroscopic material. In addition, metal nitrates, such as zinc nitrate, magnesium nitrate, and iron nitrate, can also be used as the hygroscopic agent.

There are several organic ions which form deliquescent salts which are also sufficiently hygroscopic to serve in this invention. These include sodium formate, sodium ethyl sulfate and magnesium acetate. In addition, purely organic materials, such as polyethylene glycol or polyvinyl pyrrollidone are useful in absorbing water from the atmosphere.

In one preferred embodiment, the deliquescent material is uniformly dispersed in the PEM polymer. This may be achieved by dissolving or dispersing both the PEM polymer and the deliquescent material in a common solvent or dispersing medium to form a solution or suspension. The solution or suspension is then made into a layer of modified PEM by spin-casting, printing, spraying, or any other polymer processing technique that involves eventually removing the common solvent or medium. Typically, the volume fraction of the deliquescent material in the PEM composition (deliquescent material+PEM polymer) may vary from 0.5% to 50%, but preferably from 5% to 25%. When the volume fraction of the deliquescent material exceeds 30-40%, the over-all proton conductivity in the PEM composition begins to decrease significantly.

The deliquescent material by being hygroscopic maintains the membrane moisturized at all times. The level of moisture within the PEM may vary depending on the deliquescent material selected, its concentration and air humidity. Suitable deliquescent materials include, but are not limited to, zinc chloride, calcium chloride, magnesium chloride, lithium chloride, calcium bromide, potassium biphosphate, potassium acetate, phosphorous oxide, ammonium acetate, sodium acetate, sodium silicate, potassium silicate, magnesium sulfate, aluminum oxide, calcium oxide, silicon oxide, zeolite, barium oxide, cobalt chloride, bentonite, montmorillonite clay, silica gel, molecular sieve, monohydric compounds, polyhydric compounds, metal nitrate salt, sodium ethyl sulfate organic salt, polyethylene glycol, and combinations thereof.

### EXAMPLE 1

A solution containing 240 mg of poly(perfluoro sulfonic acid) (PPSA) and 120 mg of zinc chloride (a deliquescent material) in 3.0 ml of ethanol was prepared. This solution was then cast onto a piece of glass with the solvent evaporated in a chemical fume hood to form a layer of PPSA-ZnCl₂ mixture (sample 1B). A baseline sample (sample 1A) containing only PPSA, without any zinc chloride, was prepared by following a similar procedure. Both the mixture sample and the PPSA-only sample were placed in a low-humidity oven maintained at 80° C. (a typical fuel cell operating temperature) for two weeks. The mixture (sample 1B or the PEM composition) appeared to maintain a good level of moisture, but the baseline sample (sample 1A) was dry and rigid.

### EXAMPLE 2

A perfluoro sodium sulfonate type ion exchange polymer material in a powder form having an equivalent weight of 1080 g/eq represented by the following formula (VI) was prepared: 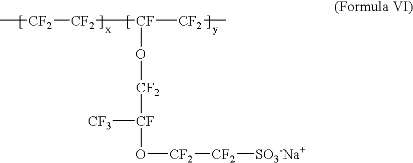
wherein x/y ratio is 6.36. The prepared ion exchange membrane was dipped in a swelling treatment liquid (ethylene glycol) at a constant temperature of 130° for 3 hours. Next, the membrane was dipped in 0.1 mol/l sodium hydroxide at 90° C. for 12 hours, dipped in a 1 mol/l sulfuric acid solution at 60° C. for 12 hours, and then was boiled in a mixture of water and ethanol for 2 hours. The resulting sample 2A has a structure represented by Formula I, with Na⁺ being replaced by H⁺. The above procedure is an ion exchange treatment.

Sample 2B was prepared in a similar manner as sample 2A, with the exception that a certain amount of calcium chloride was added to the water-ethanol mixture to obtain a slurry containing the polymer, the deliquescent material (CaCl₂), and the liquid mixture. The slurry was cast onto a glass substrate to obtain a layer of PEM composition. Both sample 2A and sample 2B were placed in a low-humidity oven maintained at 80° C. for two weeks. Sample 2B (PEM composition) appeared to maintain a much higher level of moisture as compared to sample 2A.

### EXAMPLE 3

Sample 3A and 3B were prepared by using procedures similar to those for samples 2A and 2B, respectively, with the exception that the starting material was represented by formula VII: 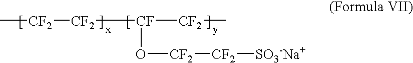
and the resulting polymer after the ion exchange treatment was represented by formula VIII: 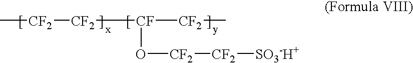
This is a special case of Formula V with a=0 and b=2. Again, with the presence of a deliquescent material, sample 3B maintains moisture much more effectively than does sample 3A.

### EXAMPLE 4

The catalyst material (a powder of Pt dispersed on carbon) is first prepared in liquid ink form by thoroughly mixing together appropriate amounts of catalyst and a solution of the membrane composition (95% Nafion® from du Pont and 5% potassium biphosphate) in alcohol. A layer of catalyst ink was then painted onto a dry, solid piece of the same membrane composition (95% Nafion® and 5% potassium biphosphate). The wet catalyst layer and the membrane were heated until the catalyst layer was dry. The membrane was then turned over and the procedure was repeated on the other side. Catalyst layers are now on both sides of the membrane. The dry membrane/electrode assembly (MEA) was next re-hydrated by immersing in lightly boiling dilute acid solution to ensure that the membrane is in the H⁺ form needed for proton conduction. The MEA was then thoroughly rinsed in distilled water (sample 4B). A similar procedure was followed to prepare a baseline MEA comprising a layer of pure Nafion® (sample 4A).

### EXAMPLE 5

For each of samples 4A and 4B, the MEA was inserted into the hardware of the fuel cell, including backing layers, flow fields, and current collectors. A porous carbon paper of approximately 100 μm thick, treated with Teflon®, was used as a backing layer. One backing layer was attached to one side of an MEA and another backing layer attached to the other side. One electronically conducting plate was then pressed against the outer surface of each backing layer. The two plates serve the dual role of flow field and current collector for both cathode and anode. The side of a plate next to the backing layer contains channels machined into the plate. The channels are used to carry the reactant gas from the point at which it enters the fuel cell to the point at which the gas exits. The two fuel cells containing 4A and 4B as an MEA are referred to as samples 5A and 5B, respectively. The two fuel cells were evaluated by allowing the two to operate in an environmental chamber where temperature and humidity were programmed to fluctuate with time. It was found that sample 5B (containing a deliquescent material) provided a relatively constant current level for a longer period of time as compared with sample 5A. Sample 5A fluctuated significantly with the humidity level, providing a lower current valve when humidity was low.

In addition to the above five examples, more fuel cells were prepared to determine if incorporation of a deliquescent material in different parts of a fuel cell (than the membrane electrode) would have any effect on the performance of a fuel cell. We were surprised to observe that a more steady, constant-current output was achieved with fuel cells that contain a thin layer of deliquescent material coated onto the surface of an electrode, a backing layer, or gas flow channels of a field plate/current collector. It appeared that the presence of a proper amount of deliquescent materials somewhere along the flow path of a reactant gas (hydrogen or air) helped to maintain a dynamic equilibrium of moisture inside a fuel cell. When the ambient humidity was high, the deliquescent material became slightly more wet by absorbing more water vapor. When the ambient humidity was low, the deliquescent material served to capture the reaction product (water) and released certain amount of water back to the membrane to help maintain the proton conductivity. It appeared more advantageous to position the deliquescent material on the cathode side than the anode side. It also worked well when both sides contained a deliquescent material.

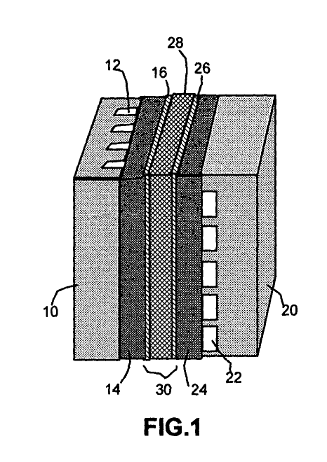

Thus, another preferred embodiment of the present invention is a fuel cell (FIG. 1) comprising a central polymer electrolyte membrane 28 with two primary surfaces, two separate electrode/catalyst layers 16,26 each with an inner layer attached to or integral with one of the two primary surfaces, two backing layers 14,24 attached to the outer surfaces of the electrode/catalyst layers, and two respective flow field/current collector plates 10,20 pressed against the outer surfaces of the backing layers 14,24. Inside the anode current collector/flow field plate 10 are built-in channels 12 for hydrogen fuel transport. Similarly, the cathode current collector/flow field plate 20 has flow channels 22 to admit air or oxygen and to exit water and un-used air. The polymer electrolyte membrane 28, the anode catalyst layer 16 and the cathode catalyst layer 26 together constitute a membrane/electrode assembly (MEA). In this fuel cell, at least one of the seven (7) layers comprises a desired amount of a deliquescent material, which serves to self-moisturize the membrane layer. Preferably, more than one layer of the seven-layer fuel cell structure comprises a deliquescent material. Further preferably, the deliquescent material is coated on the surface of gas-guiding channels of a flow field plate-current collector, or coated on a surface (either facing the flow field plate or the MEA electrode) of a GDE or backing layer.

While the invention has been described with respect to a limited number of embodiments, it will be appreciated that many variations, modifications and other applications of the invention may be made

1. A self-moisturizing polymer electrolyte membrane composition for use in a fuel cell, said composition comprising
(a) a proton-conducting polymer comprising a detachable hydrogen ion and a counter-ion bonded to said polymer; and
(b) a deliquescent material for keeping said membrane wet and for detaching said hydrogen ion to facilitate proton transport in said membrane.

2. The membrane as defined in claim 1, wherein said deliquescent material is selected from the group consisting of zinc chloride, calcium chloride, magnesium chloride, lithium chloride, calcium bromide, potassium biphosphate, sodium formate, potassium acetate, phosphorous oxide, ammonium acetate, sodium acetate, sodium silicate, magnesium acetate, potassium silicate, magnesium sulfate, aluminum oxide, calcium oxide, silicon oxide, zeolite, barium oxide, cobalt chloride, bentonite, montmorillonite clay, silica gel, molecular sieve, monohydric compounds, polyhydric compounds, metal nitrate salt, sodium ethyl-sulfate organic salt, polyethylene glycol, polyvinyl pyrrollidone, and combinations thereof.

3. The membrane as defined in claim 1, wherein said proton-conducting polymer is selected from the group consisting of poly(perfluoro sulfonic acid), its chemical derivative, its copolymer, its blend with a second polymer, and combinations thereof.

4. The membrane as defined in claim 1, wherein said proton-conducting polymer is selected from the group represented by the formula: 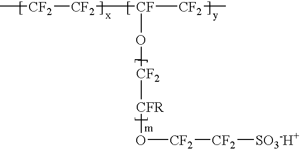
where x and y are integers selected from 1 to 100,000, m is an integer selected from 0 to 10 and R is a functional group selected from the group consisting of H, F, Cl, Br, I, and CH₃.

5. The membrane as defined in claim 1, wherein said proton-conducting polymer is characterized by comprising a structure having a substantially fluorinated backbone which has recurring pendant groups attached thereto and represented by the general formula:
—O(CFR_{f}′)_{b}—(CFR_{f})ₐ—SO₃H
where a=0-3, b=0-3, a+b=at least 1, R_{f} and R_{f}′ are independently selected from the group consisting of a halogen and a substantially fluorinated alkyl group having one or more carbon atoms.

6. The membrane as defined in claim 1, wherein said proton-conducting polymer comprises a repeating unit represented by the following formula: 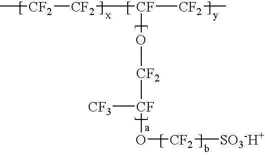
where a is 0, 1, or 2, b is 2 or 3, x and y are positive integer numbers and x/y ratio is of 10 or less.

7. A membrane/electrode assembly (MEA) comprising an anode, a cathode, and a polymer electrolyte membrane as defined in claim 1 and being interposed between said anode and said cathode, said anode and said cathode comprising electro-catalysts thereon or therein.

8. A self-moisturizing fuel cell comprising:
(a) a central polymer electrolyte membrane as defined in claim 1 for proton transport, said membrane comprising two opposite primary surfaces;
(b) two electro-catalyst layers on the two opposite sides of the electrolyte membrane in which the chemical reactions occur;
(c) two gas diffusion electrodes stacked on said electro-catalyst layers, each gas diffusion electrode comprising an electronically conducting, porous material through which reactants and reaction products diffuse in and out of the cell; and
(d) two flow field plates stacked on said gas diffusion electrodes.

9. A self-moisturizing fuel cell comprising:
(a) a central polymer electrolyte membrane as defined in claim 2 for proton transport, said membrane comprising two opposite primary surfaces;
(b) two electro-catalyst layers on the two opposite sides of the electrolyte membrane in which the chemical reactions occur;
(c) two gas diffusion electrodes stacked on said electro-catalyst layers, each gas diffusion electrode comprising an electronically conducting, porous material through which reactants and reaction products diffuse in and out of the cell; and
(d) two flow field plates stacked on said gas diffusion electrodes.

10. A self-moisturizing fuel cell comprising:
(a) a central polymer electrolyte membrane as defined in claim 3 for proton transport, said membrane comprising two opposite primary surfaces;
(b) two electro-catalyst layers on the two opposite sides of the electrolyte membrane in which the chemical reactions occur;
(c) two gas diffusion electrodes stacked on said electro-catalyst layers, each gas diffusion electrode comprising an electronically conducting, porous material through which reactants and reaction products diffuse in and out of the cell; and
(d) two flow field plates stacked on said gas diffusion electrodes.

11. A self-moisturizing fuel cell comprising:
(a) a central polymer electrolyte membrane as defined in claim 4 for proton transport, said membrane comprising two opposite primary surfaces;
(b) two electro-catalyst layers on the two opposite sides of the electrolyte membrane in which the chemical reactions occur;
(c) two gas diffusion electrodes stacked on said electro-catalyst layers, each gas diffusion electrode comprising an electronically conducting, porous material through which reactants and reaction products diffuse in and out of the cell; and
(d) two flow field plates stacked on said gas diffusion electrodes.

12. A self-moisturizing fuel cell comprising:
(a) a central polymer electrolyte membrane as defined in claim 5 for proton transport, said membrane comprising two opposite primary surfaces;
(b) two electro-catalyst layers on the two opposite sides of the electrolyte membrane in which the chemical reactions occur;
(c) two gas diffusion electrodes stacked on said electro-catalyst layers, each gas diffusion electrode comprising an electronically conducting, porous material through which reactants and reaction products diffuse in and out of the cell; and
(d) two flow field plates stacked on said gas diffusion electrodes.

13. A self-moisturizing fuel cell comprising:
(a) a central polymer electrolyte membrane as defined in claim 6 for proton transport, said membrane comprising two opposite primary surfaces;
(b) two electro-catalyst layers on the two opposite sides of the electrolyte membrane in which the chemical reactions occur;
(c) two gas diffusion electrodes stacked on said electro-catalyst layers, each gas diffusion electrode comprising an electronically conducting, porous material through which reactants and reaction products diffuse in and out of the cell; and
(d) two flow field plates stacked on said gas diffusion electrodes.

14. A self-humidifying fuel cell comprising:
(a) a central polymer electrolyte membrane layer for proton transport, said membrane having two opposite primary surfaces;
(b) two electro-catalyst layers on the two opposite sides of the polymer electrolyte membrane in which the fuel cell electro-chemical reactions occur;
(c) two gas diffusion electrode layers stacked on said two electro-catalyst layers, each gas diffusion electrode comprising an electronically conducting, porous material through which reactants and reaction products diffuse in and out of the cell; and
(d) two flow field plate layers stacked on said gas diffusion electrodes;
wherein at least one of said membrane layer, electro-catalyst layers, gas diffusion layers, or flow field plate layers comprises a deliquescent material.

15. The fuel cell as defined in claim 14, wherein at least two of said layers comprise a deliquescent material.

16. The fuel cell as defined in claim 14, wherein said polymer electrolyte membrane comprises a deliquescent material.

17. The fuel cell as defined in claim 14, wherein said deliquescent material is selected from the group consisting of zinc chloride, calcium chloride, magnesium chloride, lithium chloride, calcium bromide, potassium biphosphate, sodium formate, potassium acetate, phosphorous oxide, ammonium acetate, sodium acetate, sodium silicate, magnesium acetate, potassium silicate, magnesium sulfate, aluminum oxide, calcium oxide, silicon oxide, zeolite, barium oxide, cobalt chloride, bentonite, montmorillonite clay, silica gel, molecular sieve, monohydric compounds, polyhydric compounds, metal nitrate salt, sodium ethyl-sulfate organic salt, polyethylene glycol, polyvinyl pyrrollidone, and combinations thereof.

18. The fuel cell as defined in claim 14, wherein said membrane polymer is selected from the group consisting of poly(perfluoro sulfonic acid), its chemical derivative, its copolymer, its blend with a second polymer, and combinations thereof.

19. The fuel cell as defined in claim 16, wherein said deliquescent material is selected from the group consisting of zinc chloride, calcium chloride, magnesium chloride, lithium chloride, calcium bromide, potassium biphosphate, sodium formate, potassium acetate, phosphorous oxide, ammonium acetate, sodium acetate, sodium silicate, magnesium acetate, potassium silicate, magnesium sulfate, aluminum oxide, calcium oxide, silicon oxide, zeolite, barium oxide, cobalt chloride, bentonite, montmorillonite clay, silica gel, molecular sieve, monohydric compounds, polyhydric compounds, metal nitrate salt, sodium ethyl-sulfate organic salt, polyethylene glycol, polyvinyl pyrrollidone, and combinations thereof.

20. The fuel cell as defined in claim 16, wherein said membrane polymer is selected from the group consisting of poly(perfluoro sulfonic acid), its chemical derivative, its copolymer, its blend with a second polymer, and combinations thereof.

21. A self-moisturizing polymer electrolyte membrane composition for use in a fuel cell, said composition comprising
(a) a proton-conducting polymer capable of transporting hydrogen ion when a sufficient amount of moisture is present; and
(b) a deliquescent, hygroscopic, desiccant, water absorbent, or moisture exchange material for keeping said membrane wet to facilitate proton transport in said membrane.

22. A membrane/electrode assembly (MEA) comprising an anode, a cathode, and a polymer electrolyte membrane as defined in claim 21 and being interposed between said anode and said cathode, said anode and said cathode comprising electro-catalysts thereon or therein.

23. A self-moisturizing fuel cell comprising:
(a) a central polymer electrolyte membrane as defined in claim 21 for proton transport, said membrane comprising two opposite primary surfaces;
(b) two electro-catalyst layers on the two opposite sides of the electrolyte membrane in which the chemical reactions occur;
(c) two gas diffusion electrodes stacked on said electro-catalyst layers, each gas diffusion electrode comprising an electronically conducting, porous material through which reactants and reaction products diffuse in and out of the cell; and
(d) two flow field plates stacked on said gas diffusion electrodes.
